(19) United States
(12) Patent Application Publication
(10) Pub. No.: US 2007/0043554 A1
(43) Pub. Date: Feb. 22, 2007

(54) Vital elements of speech recognition

(76) Inventors: Anuthep Benja-Athon, New York, NY (US); Sirikit Benja-Athon, Port Washington, NY (US)

Correspondence Address: ANUTHEP BENJA-ATHON, 210 E 36th St, New York, NY, 10016, US

(21) Appl. No.: 11/543,895

(22) Filed: Oct. 6, 2006

Related U.S. Application Data
(63) Continuation-in-part of application No. 11/510,820, filed on Aug. 28, 2006.
(63) Continuation-in-part of application No. 11/477,121, filed on Jun. 29, 2006.
Application No. 11/477,121 is a continuation-in-part of application No. 11/255,229, filed on Oct. 21, 2005.
Application No. 11/255,229 is a continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.

(51) Int. Cl. G06F 17/28

(52) U.S. Cl. 704/4

(57) ABSTRACT

The grammar rules for compensating for variations in digital voice data on health and health-care data generated by physicians in the speech recognition process of the data. The grammar rules effect the presences and uses of certain vital elements and phrases in hierarchies of lists, groups, elements and phrases representing words, terms and speech phrases in the data. The result of implementing the vital elements and phrases is to further optimize the speech recognition of the data.

This application is a continuation-in-part of Ser. No. 11/510,820 entitled Words for Managing Health and Health-care Information filed Aug. 28, 2006 and is a continuation-in-part of Ser. No. 11/477,121 entitled the Medical Vocabulary Templates in Speech Recognition filed Jun. 29, 2006 which is a continuation-in-part of Ser. No. 11/255,229 entitled the Best Method of Computerized Transcriptions filed Oct. 21, 2005 which is continuation-in-part of Ser. No. 11/114,763 entitled System of Influencing Health-Care Utilizations filed Apr. 27, 2005 which is a continuation-in-part of Ser. No. 11/074,236 entitled System of Health-Care Resources file Mar. 07, 2005 and Ser. No. 11/059,088 entitled Consumers Buyers-Physicians Health-Care filed Feb. 16, 2005 which are pending.

### FIELD OF INVENTION

Vital phrases and elements in speech recognition of health and health-care data.

### BACKGROUND OF THE INVENTION

The present invention provides means and method for fine-tuning the most advanced innovation enabling the most effective and practical applications of speech recognition technology in medicine and health-care.

Applications Ser. No. 11/477,121 entitled the Medical Vocabulary Templates in Speech Recognition, Ser. No. 11/510,820 entitled Words for Managing Health and Health-care Information and Ser. No. 11/255,229 entitled the Best Method of Computerized Transcriptions are the most innovative technology on speech recognition of computerized conversions of digital audio, voice or speech data on health and health-care data on millions of patients produced by thousands of physicians to digital text data. Thus, said inventions provide physicians, computers and servers and their speech recognition engines with the best and most innovative means for speech recognition of said data.

Better yet, the present invention provides means, methods and processes for compensating for the variations and differences in said data generated by physicians and further improves and enhances the goals and objectives of said pending applications.

Specifically, the present invention provides the means, methods and processes of using and applying specific elements and phrases in the computer program paths in said speech recognitions of said data.

Therefore, the present invention provides an even more versatile system for accurately and rapidly converting massive data on health and health-care information on hundred of millions of patients generate by millions of brains of physicians into digital data. Said pending and present applications will certainly channel billions of health-care dollars, tangible and intangible benefits per day to positively affect and improve the lives of millions of people in America and the world. Therefore, the current health-care crisis is resolved by said patent applications.

Said inventions are the only systems of causing physicians in America and the world to adopt and practice the processes of converting the products of their minds on said data into computer digital data.

### SUMMARY OF THE INVENTION

The present invention provides means and method for fine-tuning the most innovative technology of speech recognition of digital voice data comprising health and health-care information on patients.

According to said pending patent applications, the present invention uses said system of hundreds to thousands of templates of medical and surgical words, terms, phrases, acronyms, synonyms, codes used, use and to be used in medicine and surgery by physicians and other health-care providers in about 80 medical and surgical specialties or practices to communicate and record health and health-care information and data. The speech grammar files in computers and/or servers comprise templates of hierarchies of lists, groups, elements and phrases representing said words, terms, phrases, acronyms, synonyms and codes for optimizing the outcomes of speech recognition of said digital voice data. In the speech recognition of physicians' said digital voice data, said pending patent applications and the present application teach an innovative system of using the speech grammar files and rules to achieve the goals and objectives of said applications.

In addition, the present invention provides the additional grammar rules for compensating for variations or differences among immense said digital voice data in the speech recognition process of said data. The additional grammar rules effect the presences and uses of certain vital elements and phrases in said hierarchies of lists, groups, elements and phrases. The results of implementing said vital elements and phrases in said grammar files further empower said pending patent applications.

### DESCRIPTION OF THE PREFERRED EMBODIMENTS

Since the filing of said patent applications, more research and further refinement of the present patent applicants' creativity have resulted in the present patent application for further optimizing or improving the accuracy and outcomes of the speech recognition of digital voice data generated by physicians to digital text data.

In order to facilitate the understanding of the present description of the preferred embodiments, it is necessary to recapitulate the preferred embodiments of said patent applications—the Medical Vocabulary Templates in Speech Recognition and Words for managing health and health-care information.

According to said pending patent applications, the present invention uses said system of hundreds to thousands of templates of medical and surgical words, terms, phrases, acronyms, synonyms, codes used, use and to be used in medicine and surgery by physicians and other health-care providers in about 80 medical and surgical specialties or practices to communicate and record health and health-care information and data and to optimize the outcomes of speech recognition of digital voice data.

In addition, the speech grammar files in computers and/or servers comprise templates of hierarchies of lists, groups, elements and phrases representing said words, terms, phrases, acronyms, synonyms and codes for optimizing the outcomes of speech recognition of said digital voice data. In the speech recognition of physicians' said digital voice data, said pending patent applications and the present application teach an innovative system of using the speech grammar files and rules to achieve the goals and objectives of said applications.

It is to be understood that said lists represent types, categories, headings and topics in medicine, surgeries and health-care. Said types, categories, headings and topics comprise words, terms, phrases, acronyms, synonyms and codes used, use and to be used by physicians and health-care providers in all medical and surgical specialties and practices on and relating to Activities such as consultation, office visit, examination, etc., Time and Durations, Drug Allergies, Food Allergies, Chief Complaints, Complaints, Manifestations, Clinical Findings, Diagnoses, Differential Diagnoses, Medications and related information, Treatments, Procedures, Prescriptions, Surgeries, Tests, Recommendations, Referred Physicians, Hospital, Clinics and Messages, etc.

It is to be understood that the links and associations of relevant and related grammar elements and phrases representing relevant and related medical and surgical words, terms, speech phrases, acronyms, synonyms and codes in digital voice data or information on health and health-care data on patients generated by physicians practicing about 80 medical and surgical specialties or fields—represented infra and in said pending patent applications—in the grammar files in the speech recognition program, programs and software are important according to the teachings of said pending patent applications and present invention. Said relationships can be further understood by viewing said grammar files in the Grammar Editor window of Microsoft Corporation speech recognition programs.

A grammar system for matching said digital voice data with phrases and elements in grammar files for optimizing the outcomes of the computerized process of converting said digital voice data into digital text data comprising grammar files wherein grammar rules effect speech recognition paths in the hierarchies of paths, lists, elements and phrases representing words, terms, speech phrases, acronyms, synonyms and codes in said digital voice data comprises a grammar means for achieving matches of said digital data with phrases and elements in said paths.

There are grammar files for and applicable to every medical or surgical specialty or practice. In each grammar file, there is at least one grammar rule although grammar rules prevail. Grammar rules effect hierarchies or arrangements of hundreds to thousands of elements and phrases representing words, terms, and speech phrases in said data. Each hierarchy comprises several to tens or hundreds of lists (columns) or groups and hundreds to thousands of elements and phrases representing words, terms, speech phrases, acronyms, synonyms and codes in said health and health-care data according to earlier teachings of said pending patent applications and the present invention.

For example, infra is an abridged and extremely simple representation of a hierarchy based on a grammar rule constructed and viewable in a speech recognition program such as, but not limited to, the Grammar Editor window of the Microsoft Corporation speech recognition software/program comprising lists, elements and phrases representing one of the preferred embodiments of the present invention. Based on infra, there are already many paths for speech recognition of data by the speech recognition engine.

Sample Grammar Rule 1 showing an order of elements and phrases approximating a display on the Grammar Editor window of Microsoft Speech Recognition program.

| | | | | | |
|---|---|---|---|---|---|
| Initial | Consultation | Chief complaint | Headache | Diagnosis | Flu |
| Subsequent | Visit | Chief complaints | Back pain | Feature | Sprain |
| Extensive | Follow-up | Complaint | Face lesion | Manifestation | Acne |
| Complex | Reevaluation | Finding | Mass | Biopsy | Tumor |
| Brief | Examination | Complaints | Tics Spasm | Finding | Seizure |
| Routine | Evaluation | Manifestation | Fever | Diagnoses | Cold |

Using said software or program, said six columns and six rolls comprising elements and phrases are constructed and simplistically represented supra to describe one of the preferred embodiments of the present invention.

First, a first physician's voice file comprising digital voice data on a first patient in a computer or server may comprise a following dictation “Initial Consultation Chief complaint Headache Diagnosis Flu” (which can be also be listened to) and, in the speech recognition process in said computer or server, the speech recognition engine for converting said data to digital text data will successfully match said dictation with the first path—bold for illustration infra—comprising elements and phrases Initial Consultation Chief complaint Headache Diagnosis Flu in said grammar file based on said grammar rule.

| | | | | | |
|---|---|---|---|---|---|
| Initial | Consultation | Chief complaint | Headache | Diagnosis | Flu |
| Subsequent | Visit | Chief complaints | Back pain | Feature | Sprain |
| Extensive | Follow-up | Complaint | Face lesion | Manifestation | Acne |
| Complex | Reevaluation | Finding | Mass | Biopsy | Tumor |
| Brief | Examination | Complaints | Tics Spasm | Finding | Seizure |
| Routine | Evaluation | Manifestation | Fever | Diagnoses | Cold |

Second, similarly, a second physician's voice file comprising digital voice data on a second patient may comprise a following dictation “Initial Follow-up Finding Mass Diagnosis Acne” and, in the speech recognition process in a computer or server, the speech recognition engine for converting said data to digital text data will successfully match said dictation with yet another path—bold for illustration infra—of many said paths comprising elements and phrases Initial Follow-up Finding Mass Diagnosis Acne in said grammar file based on said grammar rule.

| | | | | | |
|---|---|---|---|---|---|
| Initial | Consultation | Chief complaint | Headache | Diagnosis | Flu |
| Subsequent | Visit | Chief complaints | Back pain | Feature | Sprain |
| Extensive | Follow-up | Complaint | Face lesion | Manifestation | Acne |
| Complex | Reevaluation | Finding | Mass | Biopsy | Tumor |
| Brief | Examination | Complaints | Tics Spasm | Finding | Seizure |
| Routine | Evaluation | Manifestation | Fever | Diagnoses | Cold |

Third, to further illustrate the earlier teachings of pending patent applications of these patent applicants and the teaching, spirit and scope of the claims of the present invention, similarly, said second or, for that matter, a third physician's voice file comprising digital voice data on said second or, for that matter, a third patient may comprise a following dictation “Complex Examination Chief complaint Fever Diagnosis Cold” and, in the speech recognition process in a computer or server, the speech recognition engine for converting said data to digital text data will successfully match said dictation with yet another path—bold for illustration infra—of many said paths comprising elements and phrases Complex Examination Chief complaint Fever Diagnosis Cold in said grammar file based on said grammar rule.

| | | | | | |
|---|---|---|---|---|---|
| Initial | Consultation | Chief Complaint | Headache | Diagnosis | Flu |
| Subsequent | Visit | Chief Complaints | Back pain | Feature | Sprain |
| Extensive | Follow-up | Complaint | Face lesion | Manifestation | Acne |
| Complex | Reevaluation | Finding | Mass | Biopsy | Tumor |
| Brief | Examination | Complaints | Tics Spasm | Finding | Seizure |
| Routine | Evaluation | Manifestation | Fever | Diagnoses | Cold |

Therefore, said simplified examples represent one of the preferred embodiments comprising, in practice and reality, immense number of paths formed by the lists and/or groups of elements and phrases representing words, terms, phrases being used by thousands of physicians according to the teachings of said pending patent applications.

The present invention provides grammar file and rule means for compensating for variations and differences in digital voice data or information on health and health-care data on patients generated by physicians in the speech recognition process of converting said digital voice data into digital text data wherein grammar files comprising hierarchies of lists, groups, elements and phrases representing words, terms, speech phrases and sentences in said data. In other words, thousands of physicians will generate diverse and different contents in digital voice data so that the present invention provides grammar files and rules to compensate for said diversity and differences to achieve the goals and objectives of the present invention and its predecessors.

For example, fourth, another physician's voice file comprising digital voice data on any patient may comprise a following dictation “Initial Chief complaint Headache Diagnosis Flu” and, in the speech recognition process in a computer or server, the speech recognition engine for converting said data to digital text data will not successfully match said dictation with any paths as said string cannot be matched by speech recognition engine because said string is missing elements or phrases present in second list (second column infra) and, consequently, no conversion is achieved.

Said Sample Grammar Rule 1

| | | | | | |
|---|---|---|---|---|---|
| Initial | Consultation | Chief complaint | Headache | Diagnosis | Flu |
| Subsequent | Visit | Chief complaints | Back pain | Feature | Sprain |
| Extensive | Follow-up | Complaint | Face lesion | Manifestation | Acne |
| Complex | Reevaluation | Finding | Mass | Biopsy | Tumor |
| Brief | Examination | Complaints | Tics Spasm | Finding | Seizure |
| Routine | Evaluation | Manifestation | Fever | Diagnoses | Cold |

However, in said fourth albeit simplified setting representing one of the preferred embodiments of the present invention, a means for matching digital data with the grammar elements and phrases in the paths comprises skip elements or phrases and the like serving same or similar function or functions are applied in said computer program, programs and/or software.

Sample Grammar Rule 2

| | | | | | |
|---|---|---|---|---|---|
| Initial | Consultation | Chief complaint | Headache | Diagnosis | Flu |
| Subsequent | Visit | Chief complaints | Back pain | Feature | Sprain |
| Extensive | Follow-up | Complaint | Face lesion | Manifestation | Acne |
| Complex | Reevaluation | Finding | Skip | Biopsy | Tumor |
| Brief | Examination | Complaints | Tics Spasm | Finding | Seizure |
| Routine | Skip | Manifestation | Fever | Diagnoses | Cold |
| | Evaluation | | Mass | | |

Consequently, in said third setting said data comprising “Initial Chief complaint Headache Diagnosis Flu” in the speech recognition process in a computer or server, the speech recognition engine for converting said data to digital text data will successfully match said dictation using said one skip element in a path—bold for illustration infra-comprising elements and phrases Initial Chief complaint Headache Diagnosis Flu in said grammar file based on said grammar rule.

| | | | | | |
|---|---|---|---|---|---|
| Initial | Consultation | Chief complaint | Headache | Diagnosis | Flu |
| Subsequent | Visit | Chief complaints | Back pain | Feature | Sprain |
| Extensive | Follow-up | Complaint | Face lesion | Manifestation | Acne |
| Complex | Reevaluation | Finding | Skip | Biopsy | Tumor |
| Brief | Examination | Complaints | Tics Spasm | Finding | Seizure |
| Routine | Skip | Manifestation | Fever | Diagnoses | Cold |
| | Evaluation | | Mass | | |

Said skip elements or phrases can be written and placed in any part or parts of said computer program, programs and/or software thence grammar files and rules effecting the paths comprising lists, groups, elements and phrases according to earlier teachings of pending patent applications of these patent applicants and the spirit and scope of the claims of the present invention. Thus, a skip element or phrase or skip elements or phrases may and can be written, placed and added throughout the paths for speech recognition without affecting the original, full or total contents of each or every grammar file. An example, the present invention provides the writing(s) and/or placing(s) just two skip elements or phrases—bold for illustration supra—but, it is to be understood that the present invention provides the writing in the grammar file(s) and rule(s) so that placings of at least one skip element or phrase or more than one skip elements or phrases in every list or column (or roll) can be achieved to achieve the goals and objectives of the present invention.

Furthermore, the present invention provides yet another means for matching digital data with the grammar elements and phrases in the program, programs, software and paths comprises “empty” elements or phrases and the like serving same or similar function or functions as said skip element or phrase are applied in said computer program, programs and/or software according to the spirit and scope of the claims of the present invention. The “empty” spaces in second and fifth lists (or columns) infra illustrate said

Sample Grammar Rule 3

| | | | | | |
|---|---|---|---|---|---|
| Initial | Consultation | Chief complaint | Headache | Diagnosis | Flu |
| Subsequent | Visit | Chief complaints | Back pain | | Sprain |
| Extensive | | Complaint | Face lesion | Manifestation | Acne |
| Complex | Reevaluation | Finding | Skip | Biopsy | Tumor |
| Brief | Examination | Complaints | Tics Spasm | Finding | Seizure |
| Routine | Skip | Manifestation | Fever | Diagnoses | Cold |
| | Evaluation | | Mass | Feature | |
| | Follow-up | | | | |

Thus, a Skip element or phrase or Skip elements or phrases and a Wildcard (for designating certain words in a phrase which can be ignored by the speech recognition engine) element or Wildcard elements will be and can be written, placed and added throughout the paths for speech recognition without affecting the original, full or total contents of each or every grammar file. An example, the present invention provides the writing(s) and/or placing(s) just two Skip elements or phrases—bold for illustration supra—but, it is to be understood that the present invention provides the writing(s) in the program(s), software, grammar file(s) and rule(s) so that placings of at least one said element or phrase or more than said elements or phrases in every list or column can be achieved to achieve the goals and objectives of the present invention. Said applications also apply to said “empty” elements or phrases to achieve the goals and objectives of the present invention.

Therefore, said simplified examples represent one of the preferred embodiments comprising, in practice and reality, immense number of paths formed by the lists and/or groups of elements and phrases including Skip, Wildcard and “empty” elements and phrases to achieve the goals and objectives of the present invention.

One of the preferred embodiments of the present invention provides grammar file and rule means for compensating for variations and differences in digital voice data or information on health and health-care data on patients generated by a physician, a group of physicians, groups of physicians and organizations of physicians in the speech recognition process of converting said digital voice data into digital text data by providing a means for and process of posing certain same elements and phrases in said hierarchies—see Grammar Rule infra.

Sample Grammar Rule 4—showing a brief representation comprising a right extension of said Grammar Rules and repeated uses of lists (or columns) of elements and phrases—columns 4-6.

| | | | | | | |
|---|---|---|---|---|---|---|
| osis | Flu | Medication | Add | Ambien | Add | Ambien |
| | Sprain | Medications | Maintain | Anaprox | Maintain | Anaprox |
| tation | Acne | Prescription | Continue | Naprosyn | Continue | Skip |
| psy | Tumor | Prescriptions | Change | Celebrex | | Naprosyn |
| ing | Seizure | Skip | Increase | Skip | Change | Celebrex |
| oses | Cold | Drug | Decrease | Tylenol | Decrease | Tylenol |
| ature | | Drugs | Unchange | Excedrin | Unchange | Excedrin |
| | | Pharmacopia | Skip | Motrin | Maintain | Motrin |
| | | Pharmacopiae | Delete | | Increase | |

Based on said grammar rule representation, said first physician or any physician's voice file comprising digital voice data on a patient in a computer or server may comprise a following dictation “Initial Consultation Chief complaint Headache Diagnosis Flu Medications Add Celebrex Discontinue Naprosyn” (with or without accompanying list or lists of elements and phrases representing dosages, uses, administrations and related pharmacology information) and, in the speech recognition process in said computer or server, the speech recognition engine for converting said data to digital text data will successfully match said dictation with the path—bold for illustration infra—comprising elements and phrases Initial Consultation Chief complaint Headache Diagnosis Flu Medications Add Celebrex Discontinue Naprosyn in said grammar file based on said grammar rule.

| | | | | | | |
|---|---|---|---|---|---|---|
| osis | Flu | Medication | Add | Ambien | Add | Ambien |
| | Sprain | Medications | Maintain | Anaprox | Maintain | Anaprox |
| tation | Acne | Prescription | Continue | Naprosyn | Continue | Skip |
| psy | Tumor | Prescriptions | Change | Celebrex | | Naprosyn |
| ing | Seizure | Skip | Increase | Skip | Change | Celebrex |
| oses | Cold | Drug | Decrease | Tylenol | Decrease | Tylenol |
| ature | | Drugs | Unchange | Excedrin | Unchange | Excedrin |
| | | Pharmacopia | Skip | Motrin | Maintain | Motrin |
| | | Pharmacopiae | Delete | | Discontinue | |
| | | | | | Increase | |

Another illustration of another path used is as follows: a digital voice file comprises “Initial Consultation Chief complaint Headache Feature Seizure Drugs Continue Ambien Unchange Excedrin (with or without accompanying list or lists of elements and phrases representing dosages, uses, administrations and related pharmacology information) and, in the speech recognition process in said computer or server, the speech recognition engine for converting said data to digital text data will successfully match said dictation with the path—bold for illustration infra—comprising elements and phrases Initial Consultation Chief complaint Headache Feature Seizure Drugs Continue Ambien Unchange Excedrin in said grammar file based on said grammar rule.

| | | | | | | |
|---|---|---|---|---|---|---|
| osis | Flu | Medication | Add | Ambien | Add | Ambien |
| | Sprain | Medications | Maintain | Anaprox | Maintain | Anaprox |
| tation | Acne | Prescription | Continue | Naprosyn | Continue | Skip |
| psy | Tumor | Prescriptions | Change | Celebrex | | Naprosyn |
| ing | Seizure | Skip | Increase | Skip | Change | Celebrex |
| oses | Cold | Drug | Decrease | Tylenol | Decrease | Tylenol |
| ature | | Drugs | Unchange | Excedrin | Unchange | Excedrin |
| | | Pharmacopia | Skip | Motrin | Maintain | Motrin |
| | | Pharmacopiae | Delete | | Discontinue | |
| | | | | | Increase | |

Furthermore, the present invention provides not only said preferred embodiment and the like but also other means for and process of speech recognizing said health and health-care data wherein said each file of said data comprises same words, terms and/or speech phrases which need to be converted in speech recognition. In other words, the elements and phrases in lists (or columns) 4 and 5 in Grammar Rule 5 infra are assigned computer attributes of 0-N, where N is finite number of repeated uses such as, but not limited to, 1, 2, 3, 4, etc. for speech recognition of repeated words, terms and/or speech phrases in said digital voice data.

Sample Grammar Rule 5—showing a brief representation comprising a further right extension of said Grammar Rules.

| | | | | | | |
|---|---|---|---|---|---|---|
| osis | Flu | Medication | Add | Ambien | Treatment | Injection |
| | Sprain | Medications | Maintain | Anaprox | Skip | Biopsy |
| tation | Acne | Prescription | Continue | Naprosyn | Treatments | Excision |
| psy | Tumor | Prescriptions | Change | Celebrex | Procedure | Skip |
| ing | Seizure | Skip | Increase | Skip | Surgery | Cautery |
| oses | Cold | Drug | Decrease | Tylenol | Test | Dermabrasion |
| ature | | Drugs | Unchange | Excedrin | Tests | Endoscopy |
| | | Pharmacopia | Skip | Motrin | Procedures | Apnea test |
| | | Pharmacopiae | Delete | | | |

Therefore, the present invention provides a grammar file means and a grammar rule means for optimizing the speech recognition of diverse and different digital voice data on health and health-care and related generated by a physician, a group of physicians, groups of physicians and organizations of physicians in all medical and surgical specialties to achieve the goals and objectives of the present invention.

Adaptations, editions and improvements of the grammar files and grammar rules including rearrangements, reordering, re-associating, adding and subtracting lists, groups, elements and phrases representing related words, terms, speech phrases, acronyms, synonyms and codes can be constantly done or achieved to fulfill the needs, applications or requirements of a physician, a group of physicians, groups of physicians and organizations of physicians in all medical and surgical specialties to achieve the goals and objectives of the present invention. Thus, according to said pending patent applications and the present invention, although hundreds or thousands of pre-defined templates including said means and processes of the present invention are provided, the contents of said templates are not fixed as said adaptations, editions and improving can be versatilely and constantly—if needs arise—made to said templates to fulfill the needs, applications or requirements of said physicians to achieve the goals and objectives of the present invention.

Although various preferred embodiments of the present invention have been described, it will be appreciated by those skilled in the art that adaptations and variations may be made without departing from the spirit of the invention and the scope of the claims.

1. A speech recognition system for converting digital voice data generated by physicians to digital text data comprising a grammar system means for speech recognizing said digital voice data into digital text data wherein grammar files and grammar rules effect hierarchies of paths, lists, groups, phrases and elements comprises:
a means for maximizing matches of said digital voice data with phrases and elements in said hierarchies;
a means for posing certain same phrases in said hierarchies;
a means for posing certain same elements in said hierarchies;
a means for designating certain phrases in said hierarchies for repeated uses;
a means for designating certain elements in said hierarchies for repeated uses;
a means for repetitively using designated phrases in said hierarchies;
a means for repetitively using designated elements in said hierarchies;
a process of achieving matches of digital voice data with phrases and elements in said hierarchies;
a process of posing certain same phrases in said hierarchies;
a process of posing certain same elements in said hierarchies;
a process of designating phrases for repeated uses;
a process of designating elements for repeated uses;
a process of repetitively using designated phrases in said hierarchies;
a process of repetitively using designated elements in said hierarchies;
a process of not applying designated phrases;
a process of applying designated phrases more than once;
a process of not applying designated elements; and
a process of applying designated elements more than once.

2. A speech system according to claim 1 wherein said means for maximizing matches of said digital voice data with phrases and elements in said hierarchies comprises Skip elements or phrases.

3. A speech system according to claim 1 wherein said means for maximizing matches of said digital voice data with phrases and elements in said hierarchies comprises Wildcard elements.

4. A grammar system for matching digital voice data comprising health and health-care information on patients generated by physicians with phrases and elements representing words, terms and speech phrases in said data in grammar files for optimizing the outcomes of the computerized process of converting said digital voice data into digital text data wherein grammar rules effect hierarchies of paths, lists, elements and phrases comprises:
a means for maximizing matches of said digital voice data with phrases and elements in said hierarchies;
a means for posing certain same phrases in said hierarchies;
a means for posing certain same elements in said hierarchies;
a means for designating certain phrases in said hierarchies for repeated uses;
a means for designating certain elements in said hierarchies for repeated uses;
a means for repetitively using designated phrases in said hierarchies;
a means for repetitively using designated elements in said hierarchies;
a process of achieving matches of digital voice data with phrases and elements in said hierarchies;
a process of posing certain same phrases in said hierarchies;
a process of posing certain same elements in said hierarchies;
a process of designating phrases for repeated uses;
a process of designating elements for repeated uses;
a process of repetitively using designated phrases in said hierarchies;
a process of repetitively using designated elements in said hierarchies;
a process of not applying designated phrases;
a process of applying designated phrases more than once;
a process of not applying designated elements; and
a process of applying designated elements more than once.

5. A grammar rule means for compensating for variations in digital voice data on health and health-care data on patients generated by physicians in the speech recognition process of converting said digital voice data into digital text data wherein grammar files comprising hierarchies of lists, groups, elements and phrases representing words, terms and speech phrases of said data comprises:
a means for maximizing matches of said digital voice data with phrases and elements in said hierarchies;
a means for posing certain same phrases in said hierarchies;
a means for posing certain same elements in said hierarchies;
a means for designating certain phrases in said hierarchies for repeated uses;
a means for designating certain elements in said hierarchies for repeated uses;
a means for repetitively using designated phrases in said hierarchies;
a means for repetitively using designated elements in said hierarchies;
a process of achieving matches of digital voice data with phrases and elements in said hierarchies;
a process of posing certain same phrases in said hierarchies;
a process of posing certain same elements in said hierarchies;
a process of designating phrases for repeated uses;
a process of designating elements for repeated uses;
a process of repetitively using designated phrases in said hierarchies;
a process of repetitively using designated elements in said hierarchies;
a process of not applying designated phrases;
a process of applying designated phrases more than once;
a process of not applying designated elements; and
a process of applying designated elements more than once.
